(19) United States
(12) Patent Application Publication
(10) Pub. No.: US 2002/0194036 A1
(43) Pub. Date: Dec. 19, 2002

(54) Travel system and travel service method

(76) Inventors: Wen-Che Cheng, Taipei Hsien (TW); Pei-Yi Lin, Taipei Hsien (TW); Tsuey-Jing Fan, Taipei Hsien (TW)

Correspondence Address: Michael D. Bednarek, SHAWPITTMAN, 1650 Tysons Boulevard, McLean, VA, 22102-4859, US

(21) Appl. No.: 10/080,565

(22) Filed: Feb. 25, 2002

(30) Foreign Application Priority Data
Jun. 13, 2001 (TW) 090114237

(51) Int. Cl. G06F 17/60

(52) U.S. Cl. 705/5

(57) ABSTRACT

A travel system and a method are applied to a business entity. The business entity associates with at least a business partner which can communicate with the travel system. The travel system includes an employee's basic data database for storing employee's basic data and employee's identification codes and a travel data database for storing the travel application data. Every employee of the business entity has an individual employee's identification code with respect to an employee's basic data. Prior to the travel, the employee needs to register a travel application data respective to the employee's identification code. The method includes steps of: 1) the travel system forming a travel services data by combining the employee's basic data and the travel application data; 2) the travel system sending the travel services data to said business partner; and 3) the business partner performing travel services according to the travel services data.

### REFERENCE TO RELATED APPLICATION

The present application claims priority to Taiwan application No.090114237, entitled “Travel System And Travel Service Method,” filed on Jun. 13, 2001.

### BACKGROUND OF THE INVENTION

(1) Field of the Invention

The invention relates to a travel system and a travel service method for the same, and more particularly to the travel system and the travel service method, for a business entity such as a computer company and the business partners associated with the business entity such as a travel agent, which can connect the travel systems of the business partners with the travel system of the business entity so as to make easy the travel services provided to the business entity by the business partners.

(2) Description of the Prior Art

Nowadays, domestic business development can no longer satisfy the expectation and vision of a prosper business entity. For such a business entity, oversea branches and international traveling have been rapidly emerged for promoting its products, services and brand to all over the world. In the meantime, the frequency of business traveling of related employee has been greatly increased as well. Among all controllable expenses of a business entity, though the travel expanse is ranked three next to the salaries and the taxes, yet current management procedures regarding the traveling can be only deemed as a procedure far away from simplicity, real-time processing and cost-down.

Generally, while an employee files an application of traveling, a traveling operator of the company will circulate the application around all related supervisors for obtaining approvals. As long as all the approvals are obtained, the traveling operator can then call a specific travel agent for further arrangement of airline tickets, hotel reservations and rental cars. In the meantime, the traveling operator still have to manage the travel insurance, related documents, etc. During the process, the traveling operator needs to communicate with the travel agent frequently for confirming all the reservations. As soon as all the reservations are done, the traveling operator can then acknowledge the employee regarding the travel arrangement. However, in the case that the employee changes or cancels his/her schedule, the traveling operator, after being noticed, shall contact immediately with the travel agent, the insurance agent and other related institutes for altering or canceling the reservations.

In the aforesaid description regarding the conventional pre-traveling management, it is obvious for the traveling operator that a time-consuming and tedious job including all the communication with the travel agent, the insurance agent and other institutes for reservations will be processed if a traveling application is filed, or in particular if the schedule of the filed application is abruptly changed. Also, the job of managing the pre-traveling by telephone-communication or by facsimile through the traveling operator will definitely increase the labor cost for the business entity. Further, due to lacking of an integral travel-management system, the employee and the related supervisors can not update the details and status of the travel application in time. Therefore, it is worthy and urgent to design a travel application system with advantages of cost down, real-time presentation, automation and integration.

### SUMMARY OF THE INVENTION

Accordingly, it is a primary object of the present invention to provide a novel travel system and a related travel service method, which can be applied to an business entity such as a computer company. The business entity is associated with at least a business partner such as a travel agency which is capable of working with the travel system of the business entity for directly contracting travel-related business of the business entity. Thereby, the travel-related personnel in the business entity can be freed from handling the travel-related business so that efficiency upon the traveling arrangement can be increased and the labor cost of the business entity can be reduced on the other hand.

In accordance with the foresaid object, the present invention provides a new travel system and the related travel service method. The travel service method of the present invention is applied to a business entity, such as a computer company for example. The business entity can associate with a plurality of business partners, such as travel agencies for example, which each business partner can connect with the travel system of the business entity for contracting travel-related business of the business entity. The travel system includes at least the employee's basic data and an employee's basic data database for storing employee's basic data and respective employee's identification codes. In this business entity, each employee is assigned to a personal employee's identification code, which is respective to an employee's basic data. Before the employee travels, his/her employee's identification code is used to login the travel system for further registering a respective travel application data. The travel application data with respect to a specific employee's identification code is then to experience following steps, which are: 1) the travel system forming a travel services data by combining the employee's basic data and the travel application data with respect to the employee's identification code; 2) the travel system sending the travel services data to the business partner; and 3) the business partner performing travel services in accordance with the travel services data, in which the travel services can include insurances and various reservations upon airlines, hotels, rental cars, etc.

The travel system of the present invention is applied to a business entity, such as a computer company for example. The business entity can associate with a plurality of business partners, such as travel agencies for example, which each business partner can connect with the travel system of the business entity for contracting travel-related business of the business entity. Prior to a travel of an employee of the business entity, he/she needs to login the travel system for registering a respective travel application data. The travel system includes: an employee's basic data database for storing employee's basic data and the respective employee's identification codes; a travel data database for storing the travel application data registered by the employee, in which each of the travel application data is mapped to one employee's identification code; a combination module for forming a travel service data by combining one of the employee's basic data and one of the travel application data in accordance with the respective employee's identification code; and a sending module for sending the travel services data to the business partner so that the business partner can perform travel services accordingly.

Furthermore, the travel system can further include a control module for informing the supervisor of the employee after the employee registering and saving thereafter the travel application data into the travel data database, for then allowing the supervisor to access the travel application data of the travel system, and further for the supervisor to re-save the travel application data into the travel data database after confirming the travel application data.

Furthermore, the travel system can further include a decision module for determining whether or not the supervisor has confirmed the travel application data. If the supervisor approves the travel application data, the combination module can integrate the employee's basic data and the travel application data to form a travel services data with respect to the employee's identification code.

By providing the travel system and the travel service method of the present invention, communication between the travel-related personnel in the business entity and the business partner can be waived so that efficiency upon the traveling arrangement can be increased and the labor cost of the business entity can be reduced on the other hand. In addition, the establishment of the travel data database is greatly helpful to the management upon travels in the business entity.

These and other objectives of the present invention will no doubt become obvious to those of ordinary skill in the art after having read the following detailed description of the preferred embodiment, which is illustrated in the various figures and drawings.

### BRIEF DESCRIPTION OF THE DRAWINGS

The present invention will now be specified with reference to its preferred embodiment illustrated in the drawings, in which:

FIG. 1 is a block diagram of an embodiment of the travel system in accordance with the present invention;

FIG. 2 is an operational flowchart of an embodiment of the travel service method in accordance with the present invention;

FIG. 3(a) to FIG. 3(e) are used to illustrate an operational embodiment of the step S1 of FIG. 2; and

FIG. 4(a) to FIG. 4(c) are used to illustrate an operational embodiment of the steps S6 and S7 of FIG. 2.

### DESCRIPTION OF THE PREFERRED EMBODIMENT

The invention disclosed herein is directed to a travel system and a travel service method. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

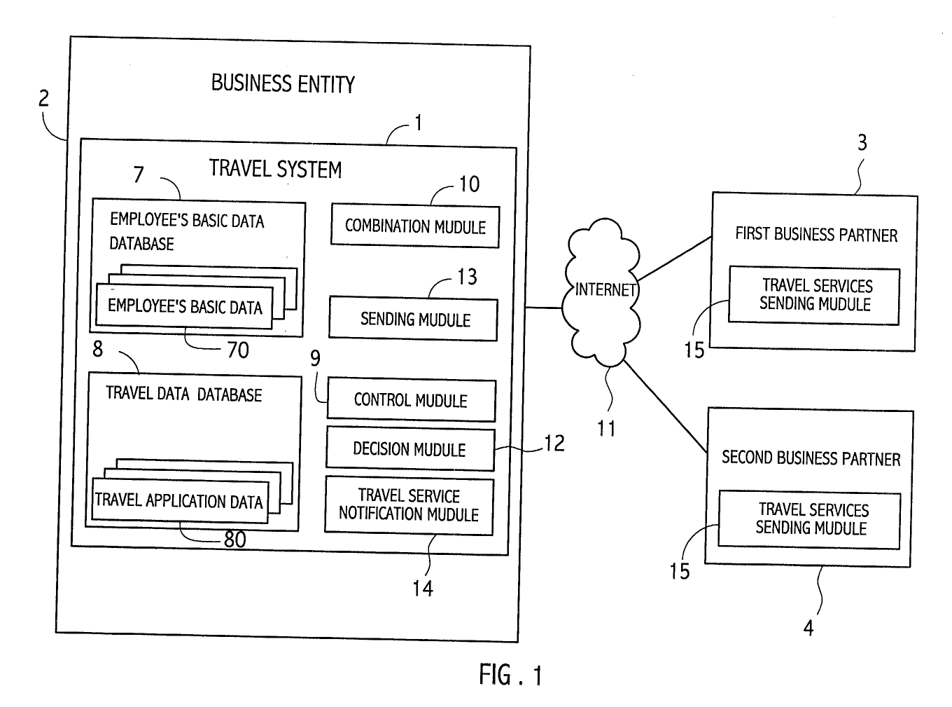

Referring now to FIG. 1, a block diagram of a preferred embodiment of the travel system 1 in accordance with the present invention is shown. As illustrated, the travel system 1 can include a business entity 2, a first business partner 3 and a second business partner 4. The business entity 2 can be a computer company, the first business partner 3 can be an insurance agency, and the second business partner 4 can be a travel agency. In the present invention, the first business partner 3 and the second business partner 4 are associated with the business entity 2.

The travel system 1 of the present invention can be constructed in a server (not shown in the drawing) of the business entity 2. Through a suitable network, the first business partner 3 and the second business partner 4 can login and thus connect with the travel system 1 of the business entity 2. In the present invention, the business entity 2, the first business partner 3 and the second business partner 4 can belong to different LAN sites but can be connected together by an internet 11 and browsers (not shown in the drawing) for data transmitting and receiving. The data through the networking can be shown in the browsers so that the first and the second business partners 3 and 4 can contract easily travel-related business with the business entity 2.

The employee can login the travel system 1 through a terminal or a personal computer connected with an intranet of the business entity 2, a WAP mobile phone, a PDA, or any other networking device.

The travel system 1 can include an employee's basic data database 7, a travel data database 8, a combination module 10, a sending module 13, a control module 9, a decision module 12, and a travel services notification module 14.

The employee basic data database 7 is used to store employee basic data 70 and employee's identification codes (not shown in drawings), in which each of the employee's basic data 70 includes the employee's department, personal identification code, birthday, passport number, and other related personal data. In particular, each of the employee's basic data 70 is respective to a corresponding employee's identification code. Therefore, before an employee of the business entity 2 travels, he/she needs to use his/her employee's identification code to login the travel system 1 for further registering a travel application data thereinto. The travel data database 8 is used to store the travel application data 80, in which the travel application data 80 includes a departure time, an arrival time, a travel destination, a temporary position deputy, a journal plan, and other travel-related data. In the present invention, each of the travel application data 80 is respective to a specific employee's identification code. After the employee registers the travel application data 80 and thereafter saves the travel application data 80 into the travel data database 8, the control module 9 can proceed to inform a supervisor of the employee and to allow the supervisor to access the travel application data 80 in the travel system 1. As soon as the supervisor confirms the travel application data 80, then the control module 9 can re-save the confirmed travel application data 80 into the travel data database 8. The combination module 10 can combine the employee's basic data and the travel application data 80 in accordance with the corresponding employee's identification code for forming a travel services data. The decision module 12 is used to determine whether or not the corresponding supervisor has confirmed the travel application data 80. if the answer is positive, the combination module 10 can integrate the employee's basic data 70 and the travel application data 80 to form a respective travel services data, in accordance with the employee's identification code. The sending module 13 is used to forward the travel services data to the first or the second business partners 3 or 4, so that the first or the second business partners 3 or 4 can provide travel services in accordance with the travel services data. The services notification module 14 is used to receive a travel services message from the first or the second business partners 3 or 4 and then transfer the travel services message to the employee and his/her supervisor.

The first or the second business partners 3 or 4 can include an individual travel services sending module 15 for generating the travel services message to the travel system 1 in accordance with the travel services data as well as derived data. In the present invention, the travel services message is respective to one of the employee's identification code. Therefore, when the travel system 1 receives the travel services message, the travel services notification module 14 can forward accordingly the travel services message to the corresponding employee and his/her supervisor.

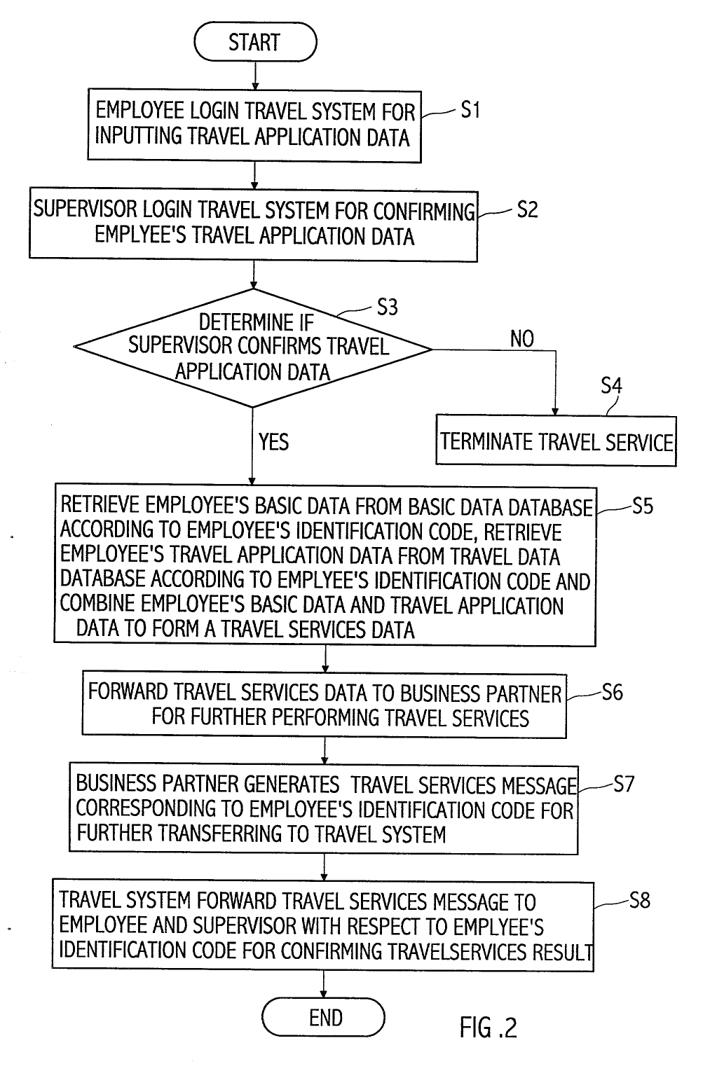

Referring now to FIG. 2, an operational flowchart of an embodiment of the travel service method in accordance with the present invention is illustrated.

Firstly in step S1, the employee can utilize his/her employee's identification code to login the travel system 1 for registering a travel application data 80 The travel application data 80 is thereafter stored into the travel data database 8. In the present invention, the travel application data 80 can include a travel purpose, a temporary position deputy, a departure time, an arrival time, a travel destination, a rental car message, etc. Then, proceed to step S2.

In the step S2, the control module 9 can base on the employee's basic data 70 to recognize a supervisor of the employee and further to notify the supervisor. The control module 9 allows the supervisor to login the travel system 1 and thus to access the travel application data 80 for further approving or confirming the travel. After the supervisor approves the travel application data 80, the control module 9 or the supervisor can store the confirmed travel application data 80 into the travel data database 8. Then, proceed to step S3.

In the step S3, the decision module 12 can determine whether or not the travel application data 80 has gained supervisor's approval or confirmation. In the case that the supervisor confirms the travel application data, proceed to perform step S5. In the case that the supervisor does not confirm the travel application data, then proceed to perform step S4.

In the step S4, the travel service method is terminated.

In the step S5, the combination module 10 can base on the employee's identification code to retrieve the corresponding employee's basic data 70 from the employee's basic data database 7. The combination module 10 can also base on the employee's identification code to retrieve the corresponding employee's travel application data 80 from the travel data database 8. Then, the combination module 10 can combine the employee's basic data 70 and the travel application data 80 together to form a respective travel services data. Then, proceed to step S6.

In the step S6, the sending module 13 can forward the travel services data to the first or the second business partners 3 or 4 so as to have the first or the second business partners 3 or 4 base on the travel services data to perform travel services. Then, proceed to step S7.

In the step S7, the first or the second business partners 3 or 4 can generate a travel services message and then send the travel services message to the travel system 1, in which the travel services message is respective to a corresponding employee's identification code. Then, proceed to step S8.

In the step S8, the travel system 1 can forward the travel services message to the employee and his/her supervisor according to the employee's identification code, for informing the result of the travel services.

Therefore, by providing the travel system and the travel service method according to the present invention, the first or the second business partners 3 or 4 can provide automatically the business entity 2 with various travel services. Thereby, the business entity 2 can provide a rapid and convenient method to employees of the business entity 2 to submit travel applications. Also, the present invention provides a labor-saving method for the business entity 2 to process various travel related business.

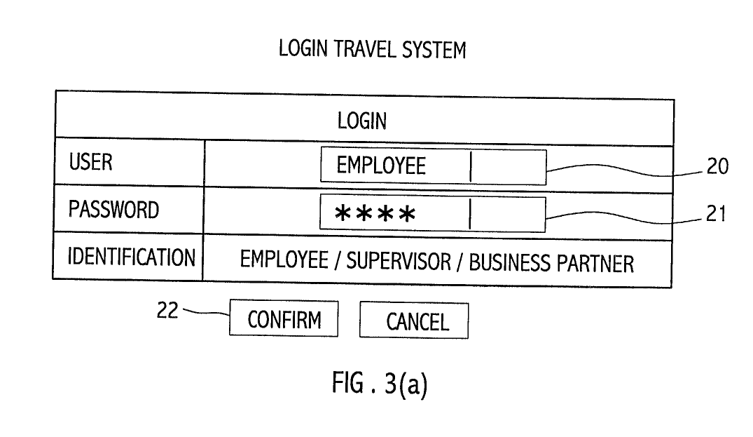

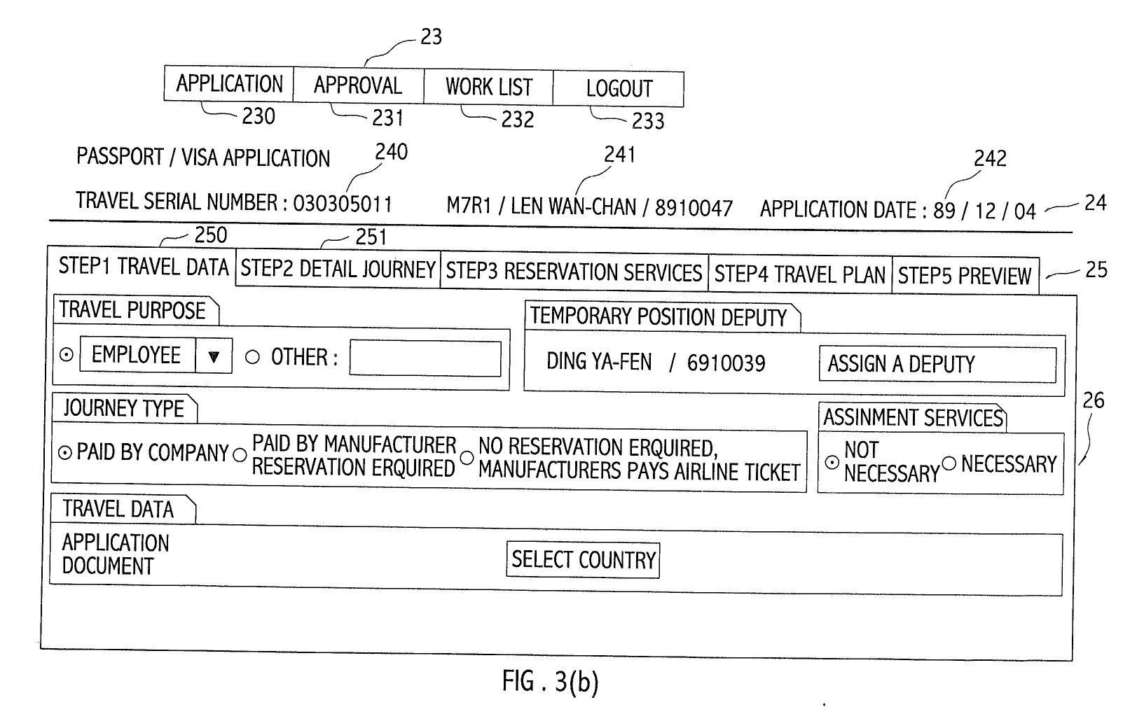

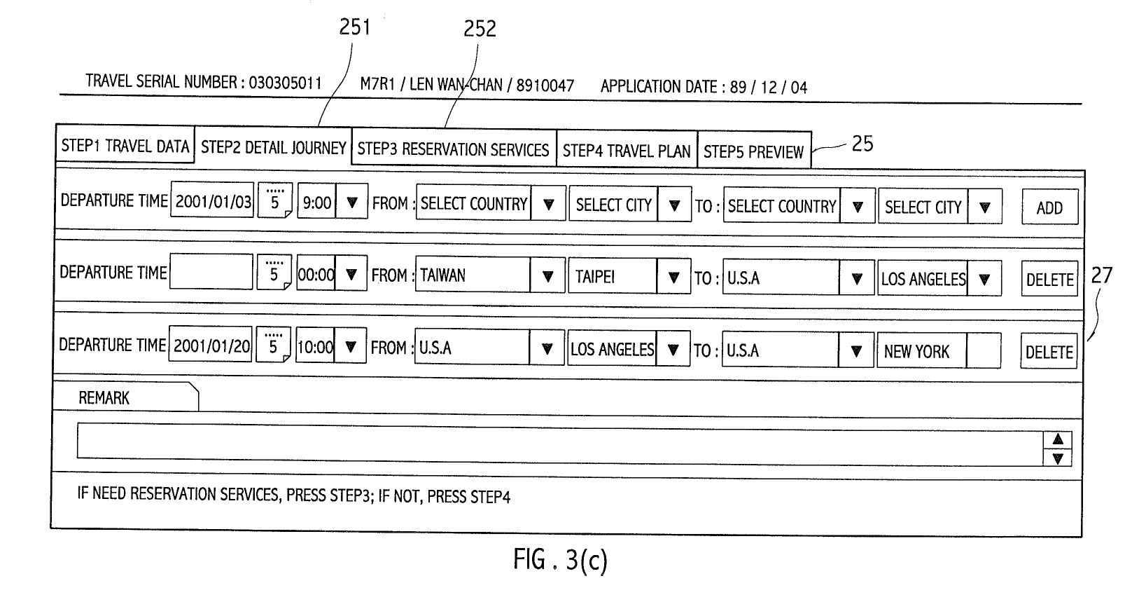

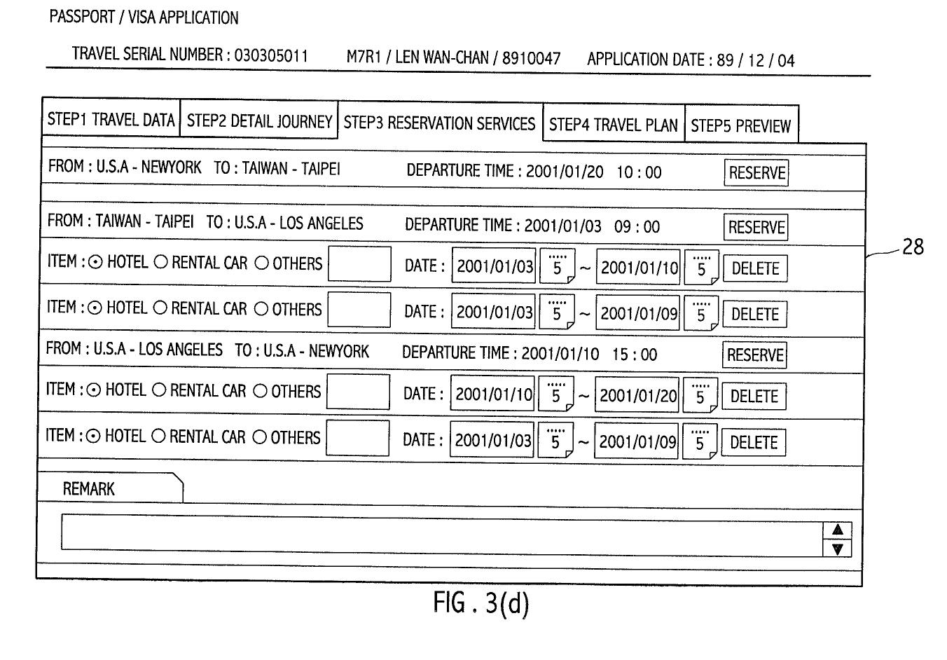

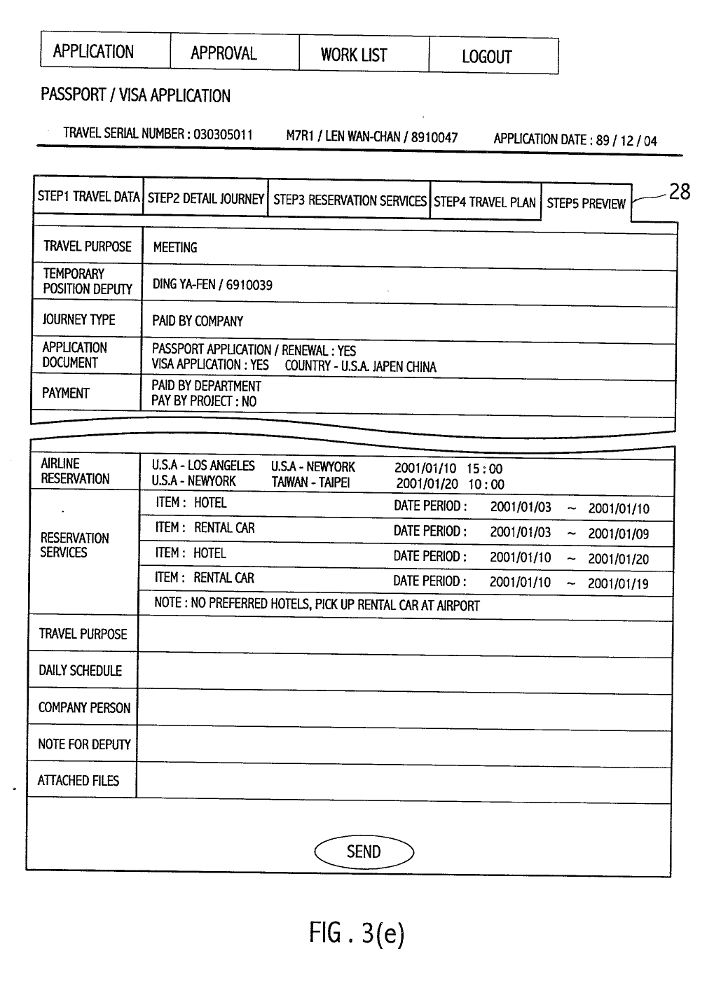

Referring now to FIG. 3(a) through FIG. 3(e), an operational embodiment of travel application data for the step S1 of FIG. 2 is shown. In the present invention, the travel application data by the user's, i.e. the employee, is input through a browser. To simplify the drawings and the description, FIG. 3(a) through FIG. 3(e) are used to show only system elements related to the present invention. For example, work lists and linked nets provided by the browser are not shown in the drawings. As shown in FIG. 3(a), a page for login the travel system 1 is illustrated. In this page, a user can input his/her identification into a word frame 20 and his/her password into another word frame 21. After the confirmation key 22 is depressed, the travel system 1 can proceed to identify the user. Since identifying the user is conventional to persons familiar with the computer operation system, it will not be described in detail herein. In the embodiment of the present invention, aforesaid password provided by the user is the employee's identification code. As shown in FIG. 3(b), it illustrates an operation bar 23, an application data bar 24, a travel application bar 25, and a travel application data table 26. Furthermore, the operation bar 23 includes an application key 230, an approval key 231, a work list key 232, and a log-out key 233. The application key 230 is used for the employee to register the travel application data 80. The approval key 231 is used for the supervisor of the employee to confirm the travel application data 80 registered by the employee to travel. The work list key 232 is used for the first or the second business partners 3 or 4 to perform travel services. The log-out key 233 is used for the user to logout the travel system 1. When the user clicks the application key 230 in the operation bar 23, the travel system 1 can base on the employee's identification code to access the employee's basic data database for obtaining the department, employee's name and employee's code (for example, M7R1/Len Wan-Chan/8910047 as shown respectively) and for further displaying the data 241, the travel sheet serial number 240 obtained from the system 1 and the application date 243 on the application data bar 24. Also, the travel application bar 25 is displayed. When the user clicks step1 travel data key 250, the travel application data table 26 can appear or can be highlighted. The travel application data table 26 is used for the user to key in basic travel data, such as the travel purpose, the temporary position deputy, the journal type, etc. After the user finishes the input, the step2 detail journey key 251 can be clicked to have a display as shown in FIG. 3(c), in which a travel application data table 27 appears to allow the user to input his/her travel plan. The travel plan can include the departure time, the arrival time, travel destination, etc. After the user complete the table 27, the step3 reservation services key 252 can be clicked to have a display of the travel application data table 28 as shown in FIG. 3(d). The travel application data table 28 is provided for the user to input all required reservations, such as the rental car, hotels, etc. After the user complete the table 28, the step5 preview key 254 can be clicked to have a display of the travel application data table 29 as shown in FIG. 3(e). The travel application data table 29 is applied to allow the user to preview all previous inputs of the travel data. After the travel data is confirmed by the user, the sending key 290 can be clicked to forward the travel application data to the travel system 1.

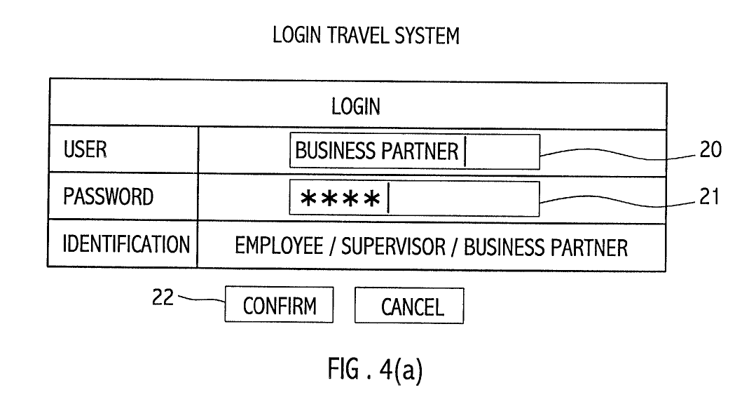

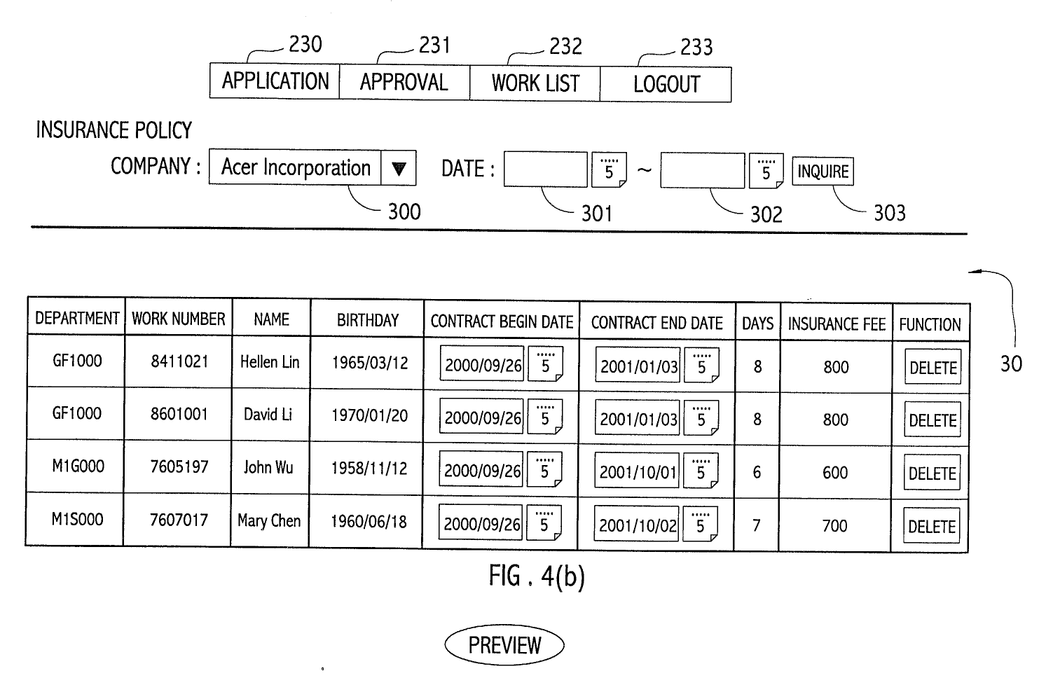

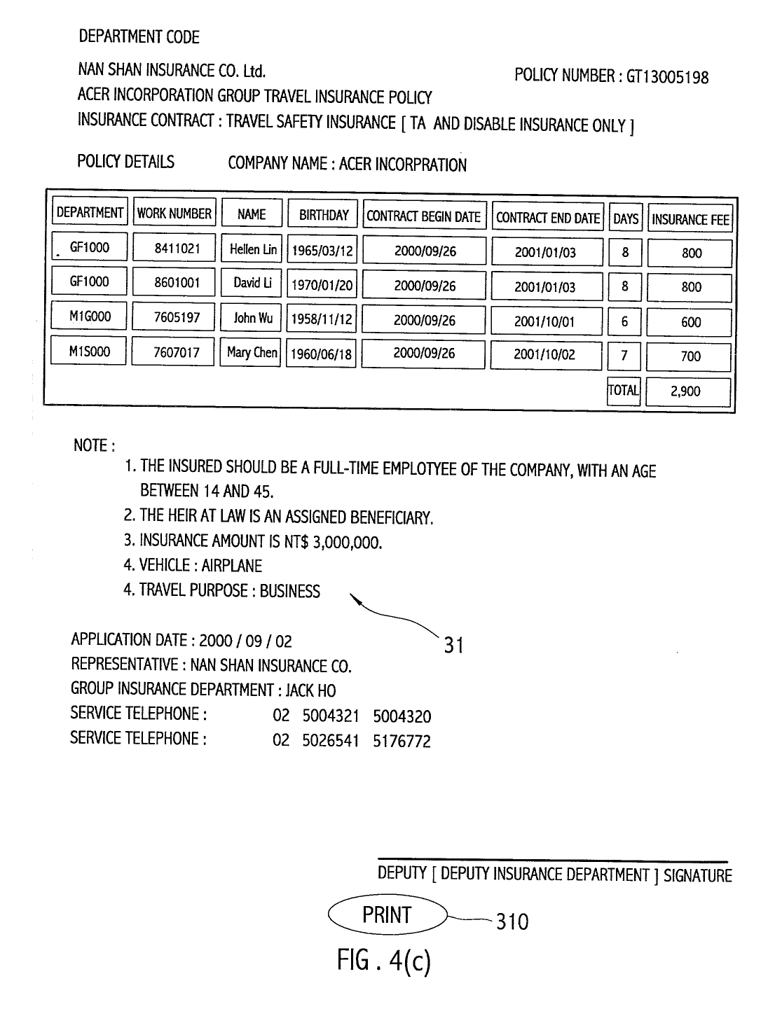

Referring now to FIG. 4(a) through FIG. 4(c), an operational embodiment upon the managing of the travel services data by the business partners in the steps S6 and S7 of FIG. 2 is shown. In this embodiment, the business partner is an insurance agency. In the present invention, the business partner (i.e. the insurance agency) can utilize a browser to manage the travel services data. First of all, as shown in FIG. 4(a), a login page of the travel system is presented for the insurance agency to key in the user name in the word frame 20 and the password in the word frame 21. After the confirmation key is clicked, the travel system 1 can identify the user. Since the business entity is associated with the business partners, the travel system 1 constructed at the business entity 2 can further include a business partner database (not shown in drawings) which includes a business partner identification password for identifying the user. As long as the travel system 1 confirms the association relationship between the business entity and the business partner, the business partner can then login the travel system 1 Thereafter, while the business partner clicks the work list key 232, a screen as shown in FIG. 4(b) can be obtained. Because the travel system 1 can identify the business partner as an insurance agency through the input business partner identification password, the travel services data can be forwarded to the business partner and can be shown on the browser (not shown in drawings) of the computer device at the business partner end. As shown in FIG. 4(b), the insurance data table 304, providing a company name field 300 for filling the name of the business entity and date range fields 301 and 302, is used for the business partner to inquire the insurance data. When the business partner confirms the insurance data table 304, the preview key 305 can be clicked to obtain a next page as shown in FIG. 4(c), in which an insurance data 31 is shown on the browser of the computer device at the business partner side. If the business partner clicks the print key 310, the insurance data 31 can then be printed. After the business partner endorses the insurance data 31, the insurance data 31 can then be sent to the business via mailing.

Compared with the prior art, the travel system and the travel service method in accordance with the present invention need no travel-related personnel in the business entity to be in charge of communicating with the business partners. Hence, labor cost can be reduced and the handling efficient can be increased. In addition, by providing the employee's travel data database, the travel management of the business entity can be greatly improved. Furthermore, by providing the association relationship between the business entity and the business partners, the business partner can provide various travel services to the business entity. Also, by providing the present invention, the business partner can present a quick and convenient solution for the employee of the business entity to submit a travel application. Therefore, the business entity can complete all its own travel-related business with timesaving, labor-saving and cost-down.

By providing the present invention, the travel system and the travel service method can easily handle the travel application and travel preparation with efficiency and low cost.

While the present invention has been particularly shown and described with reference to a preferred embodiment, it will be understood by those skilled in the art that various changes in form and detail may be without departing from the spirit and scope of the present invention.

What is claimed is:

1. A travel system for a business entity, the business entity associating with at least a business partner, every employee of the business entity having an individual employee's identification code for logging in the travel system, the employee being required to register a travel application data into the travel system prior to a travel, the travel system comprising:
an employee's basic data database for storing employee's basic data and the respective employee's identification codes;
a travel data database for storing travel application data registered by the employees, each of the travel application data being respective to one said employee's identification code;
a combination module for forming a travel service data by combining one of the employee's basic data and one of the travel application data in accordance with the respective employee's identification code; and
a sending module for sending the travel services data to the business partner so as to enable the business partner to perform travel services accordingly.

2. The travel system for a business entity according to claim 1 further includes a control module for informing a supervisor of said employee after said employee registering said travel application data and saving said travel application data into said travel data database, for allowing the supervisor to access said travel application data of said travel system, and for resaving said travel application data into said travel data database after the supervisor confirming said travel application data.

3. The travel system for a business entity according to claim 2 further includes a decision module for determining whether or not said supervisor has confirmed said travel application data; and if positive, said combination module integrates said employee's basic data and said travel application data to form a travel services data with respect to said employee's identification code.

4. The travel system for a business entity according to claim 1, wherein said business partner further includes a travel services sending module to form a travel services message in accordance with said travel services for being forwarded to said travel system, in which the travel services message is respective to one said employee's identification code.

5. The travel system for a business entity according to claim 4 further includes a travel services notification module for forwarding said travel services message from said business partner to said employee with respect to said employee's identification code.

6. The travel system for a business entity according to claim 1, wherein said employee's basic data includes an identification code, a birthday and a passport number of said employee.

7. The travel system for a business entity according to claim 1, wherein said travel application data includes a departure time, an arrival time and a travel destination of the travel.

8. The travel system for a business entity according to claim 1, wherein said business partner performs said travel services of insurance in accordance with said travel services data.

9. The travel system for a business entity according to claim 1, wherein said business partner performs said travel services of airline reservation in accordance with said travel services data.

10. The travel system for a business entity according to claim 1, wherein said business partner performs said travel services of hotel reservation in accordance with said travel services data.

11. The travel system for a business entity according to claim 1, wherein said business partner performs said travel services of rental-car reservation in accordance with said travel services data.

12. The travel system for a business entity according to claim 1, wherein said business partner is an insurance agent.

13. The travel system for a business entity according to claim 1, wherein said business partner is a travel agent.

14. The travel system for a business entity according to claim 1, wherein said business entity communicates with said business partner through a network.

15. The travel system for a business entity according to claim 14, wherein said network is an internet.

16. A travel service method, applied to a travel system of a business entity, the business entity associating with at least a business partner, every employee of the business entity having an individual employee's identification code with respect to an employee's basic data for logging in the travel system, the employee being required to register a travel application data respective to the employee's identification code into the travel system prior to a travel, the travel system having a travel data database for storing the travel application data and an employee's basic data database for storing the employee's basic data, the travel service method comprising steps of:
1) the travel system forming a travel services data by combining the employee's basic data and the travel application data with respect to the employee's identification code;
2) the travel system sending the travel services data to said business partner; and
3) the business partner performing travel services in accordance with the travel services data.

17. The travel service method according to claim 16 further includes a step (1-1) before performing said step (1) said step (1-1) includes:
1-1) informing a supervisor of said employee after said employee registering said travel application data and saving said travel application data into said travel data database, further allowing the supervisor to access said travel application data of said travel system, and then re-saving said travel application data into said travel data database after the supervisor confirming said travel application data.

18. The travel service method according to claim 17 further includes a step (1-2) sandwiched between said step (1-1) and said step (1), said step (1-2) includes:
1-2) determining whether or not said supervisor has confirmed said travel application data; and, if positive, integrating said employee's basic data and said travel application data to form a travel services data with respect to said employee's identification code.

19. The travel service method according to claim 16 further includes a step (4) after said step (3), said step (4) includes:
4) said business partner forming a travel services message respective to said employee's identification code and then forwarding the travel services message to said travel system.

20. The travel service method according to claim 19 further includes a step (5) after said step (4), said step (5) includes:
5) said travel system further forwarding said travel services message to said employee with respect to said employee's identification code.

21. The travel service method according to claim 16, wherein said employee's basic data includes an identification code, a birthday and a passport number of said employee.

22. The travel service method according to claim 16, wherein said travel application data includes a departure time, an arrival time and a travel destination of the travel.

23. The travel service method according to claim 16, wherein said business partner performs said travel services of insurance in accordance with said travel services data.

24. The travel service method according to claim 16, wherein said business partner performs said travel services of hotel reservation in accordance with said travel services data.

25. The travel service method according to claim 16, wherein said business partner performs said travel services of airline reservation in accordance with said travel services data.

26. The travel service method according to claim 16, wherein said business partner performs said travel services of rental-car reservation in accordance with said travel services data.

27. The travel service method according to claim 16, wherein said business partner is an insurance agent.

28. The travel service method according to claim 16, wherein said business partner is a travel agent.

29. The travel service method according to claim 16, wherein said business entity communicates with said business partner through a network.

30. The travel service method according to claim 29, wherein said network is an internet.
